(19) United States
(12) Patent Application Publication
(10) Pub. No.: US 2021/0061192 A1
(43) Pub. Date: Mar. 4, 2021

(54) DASH INSULATION PAD FOR VEHICLE

(71) Applicant: DAEHAN SOLUTION CO., LTD., Incheon (KR)

(72) Inventors: Choong Ho KWON, Seoul (KR); Minji YU, Incheon (KR)

(73) Assignee: DAEHAN SOLUTION CO., LTD., Incheon (KR)

(21) Appl. No.: 16/999,479

(22) Filed: Aug. 21, 2020

(30) Foreign Application Priority Data
Aug. 30, 2019 (KR) 10-2019-0106994

(51) Int. Cl. B60R 13/08; B32B 5/18

(52) U.S. Cl. CPC B60R 13/083; B32B 5/18; B32B 2266/0278; B32B 2307/304; B32B 2262/0215; B32B 2307/102

(57) ABSTRACT

A dash insulation pad for a vehicle, which is manufactured by adding thermoexpandable microcapsules when a sound insulation sheet is manufactured so that the sound insulation sheet which is heavy is lightened, to obtain required performance thereof, which is equal to or higher than that of a conventional sound insulation sheet. Particularly, a dash insulation pad for a vehicle, in which thermoexpandable microcapsules individually expanding to form air pores are added to and foamed in a sound insulation sheet so that cells in the sound insulation sheet are independently and uniformly formed even without using chemical gas and the like so that the dash insulation pad is uniformly formed and lightened.

### CROSS-REFERENCE TO RELATED APPLICATION

This application claims priority to and the benefit of Korean Patent Application No. 10-2019-0106994, filed on Aug. 30, 2019, the disclosure of which is incorporated herein by reference in its entirety.

### BACKGROUND

### 1. Field of the Invention

The present invention relates to a dash insulation pad for a vehicle, and more specifically, to a dash insulation pad for a vehicle in which thermoexpandable microcapsules are added to a sound insulation sheet when the sound insulation sheet used in the dash insulation pad is manufactured so that noise performance is not degraded and a weight of the dash insulation pad is decreased.

### 2. Discussion of Related Art

Generally, dash insulation is an interior material included in a dash panel which divides an engine room from a vehicle interior and blocks noise generated in the engine room and introduced from under the engine room and the like through the engine room so that comfortable indoor environments may be formed. The dash insulation is formed of various materials as described in Patent Documents 1 to 3.

(Patent Document 1) Korean Registered Patent No. 10-1317818

The invention is directed to providing a dash inner insulator for a vehicle that is manufactured by including a hollow fiber sound absorption layer including air pores and installed and used at an interior side of an inner dash panel to reduce noise using hollows (air pores) formed in the hollow fiber sound absorption layer and also to simultaneously achieve a heat insulation effect so that sound absorption performance is improved. In addition, the invention is also directed to providing a dash inner insulator, in which a hollow fiber sound absorption layer is formed to have a predetermined optimal size to reduce noise generated in a vehicle using the dash inner insulator so as to maximize an effect of reducing noise so that sound absorption performance is improved. In addition, the invention is also directed to providing a dash inner insulator for a vehicle, in which a hollow is formed to reduce a total weight of the insulator, to also improve a sound absorption effect, and particularly, to improve fuel efficiency due to the reduced weight so that sound absorption performance is improved.

(Patent Document 2) Korean Laid-Open Patent No. 10-2015-0072555

The invention is directed to providing a dash inner insulation for a vehicle, in which carbon nanotubes (CNTs) are added when a polyurethane foam having a sound absorption function is manufactured as a base material of a dash inner insulation to change a cell structure of the polyurethane foam so as to minimize an increase in weight of the polyurethane foam and also improve sound absorption and insulation performance Particularly, the present invention is also directed to a dash inner insulation for a vehicle, in which such a polyurethane foam is manufactured through a process which is the same as a process of manufacturing a conventional polyurethane foam but sound absorption performance is high in comparison to an increase in weight through a process in which CNTs are added in an undiluted polyurethane foam solution.

(Patent Document 3) Korean Registered Patent No. 10-1637764

The invention relates to a dash separation pad including a sound insulation member of which a thickness is changeable, and a method of manufacturing the same, and more specifically, to a dash separation pad to which a sound insulation member including a binder and a filler are applied to maintain a specific gravity equivalent to that of a sound insulation member formed of a rubber material having a high specific gravity so that sound insulation performance is high and a weight of a vehicle is also decreased, and of which the sound insulation member is not manufactured as a sheet but is manufactured through a spray process to be flexibly formed to have various thicknesses and is formed only at a portion susceptible to noise so as to effectively reduce a weight of a vehicle and also improve noise vibration harshness (NVH) performance, and a method of manufacturing the same.

However, in conventional dash insulation, a weight of a sound insulation layer used to improve sound insulation performance of noise performance is high. Accordingly, a total weight of the dash insulation is increased due to the sound insulation layer, and the increased weight acts as a factor in decreasing a fuel efficiency of a vehicle.

### RELATED ART

### Patent Document

(Patent Document 1) Korean Registered Patent No. 10-1317818 (Registration Date: Oct. 7, 2013)

(Patent Document 2) Korean Laid-Open Patent No. 10-2015-0072555 (Open Date: Jun. 30, 2015)

(Patent Document 3) Korean Registered Patent No. 10-1637764 (Registration Date: Jul. 1, 2016)

### SUMMARY OF THE INVENTION

The present invention is directed to providing a dash insulation pad for a vehicle, which is manufactured by adding thermoexpandable microcapsules when a sound insulation sheet is manufactured so that the sound insulation sheet which is heavy is lightened, to obtain required performance thereof, which is equal to or higher than that of a conventional sound insulation sheet.

Particularly, the present invention is also directed to providing a dash insulation pad for a vehicle, in which thermoexpandable microcapsules individually expanding to form air pores are added to and foamed in a sound insulation sheet so that cells in the sound insulation sheet are independently and uniformly formed even without using chemical gas and the like so that the dash insulation pad is uniformly formed and lightened.

Accordingly, the present invention is also directed to providing a dash insulation pad for a vehicle, of which a sound insulation sheet is formed to have tensile elongation performance which is similar to that of a conventional sound insulation sheet even though a specific gravity thereof is decreased and lightened by 10% or more from that of the conventional sound insulation sheet, and in which sound insulation performance which is equivalent to that of the dash insulation pad is obtained at a frequency band of 500 Hz to 3 KHz even though the sound insulation sheet is light.

According to an aspect of the present invention, there is provided a dash insulation pad for a vehicle in which a fiber layer (10), a sound insulation sheet (20) including thermoexpandable microcapsules (20′), and a foam sheet (30) are sequentially formed.

In addition, the fiber layer (10) may include polyethylene terephthalate (PET), and the foam sheet (30) may be a polyurethane sheet.

Particularly, the sound insulation sheet (20) may be formed by mixing and foaming a gum resin at 30 to 40 wt %, an inorganic filler at 50 to 60 wt %, other additives (stearic acid, w-oil, and carbon black) at 8 wt %, and the thermoexpandable microcapsules (20′) at 0.5 to 10 wt %.

In this case, a tensile strength of the sound insulation sheet may be in the range of 1 to 2.8 Mpa. In addition, a tensile elongation of the sound insulation sheet may be in the range of 160 to 230%. In addition, a specific gravity of the sound insulation sheet may be in the range of 1.1 to 1.6. In addition, a hardness (Shore A) of the sound insulation sheet may be in the range of 60 to 80. In addition, a weight of the sound insulation sheet may be in the range of 3.6 to 7.0 Kg.

Finally, the sound insulation sheet (20) may be manufactured through a calendering process.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an image showing a dash insulation pad for a vehicle according to the present invention;

FIG. 2 is a cross-sectional view showing a layer structure of the dash insulation pad for a vehicle according to the present invention;

FIG. 3 is a cross-sectional image showing a sound insulation sheet formed by adding thermoexpandable microcapsules according to the present invention;

FIG. 4 is a cross-sectional image showing the sound insulation sheet enlarged by 50 times when thermoexpandable microcapsules are not added to a sound insulation sheet and when the thermoexpandable microcapsules are added to and foamed in the sound insulation sheet; and

FIG. 5 is a graph showing comparison between sound insulation performances (TLn [dB/1]) over a frequency (Hz) with respect to the dash insulation pad (Example) to which the thermoexpandable microcapsules are added and a dash insulation pad (Comparative Example) to which foam capsules are not added.

### DETAILED DESCRIPTION OF THE INVENTION

Hereinafter, exemplary embodiments of the present invention will be described in more detail with reference to the accompanying drawings. Moreover, terms and words used in this specification and claims should not be interpreted as being limited to commonly used meanings or meanings in dictionaries and should be interpreted as having meanings and concepts which are consistent with the technological scope of the invention based on the principle that the inventors have appropriately defined concepts of terms in order to describe the invention in the best way.

Therefore, since the embodiments described in this specification and configurations illustrated in the drawings are only exemplary embodiments and do not represent the overall technological scope of the invention, it is understood that the invention covers various equivalents, modifications, and substitutions at the time of filing of this application.

[Structure]

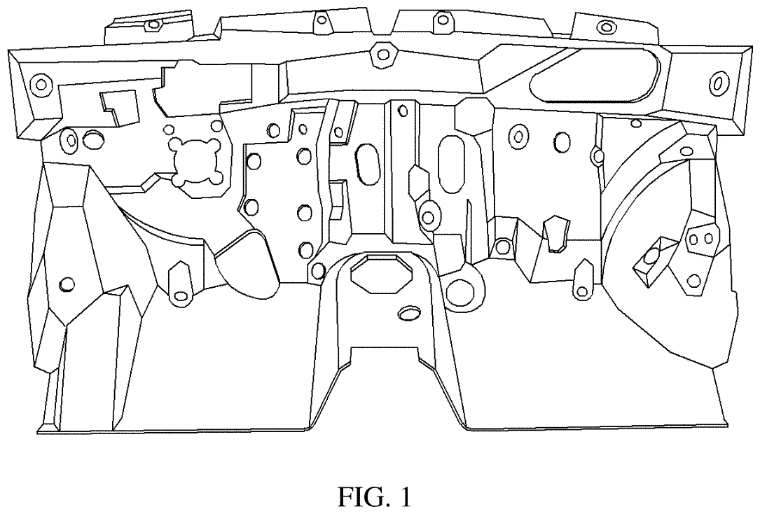

As illustrated in FIGS. 1 to 5, in a dash insulation pad for a vehicle according to the present invention, a fiber layer 10, a sound insulation sheet 20, and a foam sheet 30 are sequentially formed.

Particularly, since thermoexpandable microcapsules 20′ are added to and foamed in the sound insulation sheet 20 when the sound insulation sheet 20 is manufactured, air pores are uniformly formed in the sound insulation sheet so that the dash insulation pad is lightened and noise performance is also improved. Hereinafter, the structure will be described below in more detail with reference to the accompanying drawings.

A. Fiber Layer

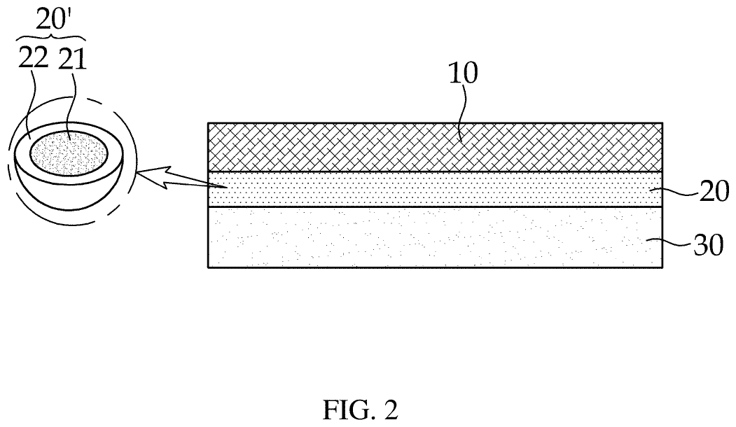

As illustrated in FIG. 2, the fiber layer 10 is formed of felt and compressed wool or animal hair fiber to have the form of a sheet, and the fiber layer 10 manufactured by felting the fiber to be tangled using vapor or heat and pressure is used. In this case, natural fiber may be used to manufacture the fiber layer 10 as described above, or natural fiber and synthetic fiber which are mixed or only synthetic fiber may be also used to manufacture the fiber layer 10.

In the exemplary embodiment of the present invention, it is most preferable to use polyethylene terephthalate (PET), which is widely used as a sound absorption material, to manufacture the fiber layer 10.

B. Sound Insulation Sheet

As illustrated in FIG. 2, the sound insulation sheet 20 is a sheet having sound insulation performance and is manufactured by mixing the thermoexpandable microcapsules 20′ when the sound insulation sheet is manufactured such that the sound insulation sheet 20 is light and performance thereof is equivalent or similar to properties of a conventional sound insulation sheet.

The sound insulation sheet 20 is manufactured by mixing and foaming a gum resin at 30 to 40 wt %, an inorganic filler at 50 to 60 wt %, other additives (a steric acid, w-oil, and carbon black) at 8 wt %, and the thermoexpandable microcapsules 20′ at 0.5 to 10 wt %.

In this case, as illustrated in FIG. 2, the thermoexpandable microcapsule 20′ includes a core 21 disposed therein and a shell 22 surrounding an outer portion of the core 21. In this case, the core 21 is manufactured of a thermoplastic resin to have a thickness of 2 to 15 μm, and the shell 22 is manufactured of hydrocarbon. The thermoexpandable microcapsule 20′ manufactured to have a total diameter of 5 to 50 μm is used.

In the exemplary embodiment of the present invention, the sound insulation sheet 20 may be manufactured through a calendering process. The calendering process is a general technology for forming a film or sheet using a rolling machine in which a plurality of heating rolls are disposed and is widely used to manufacture a film or the like having high thickness precision.

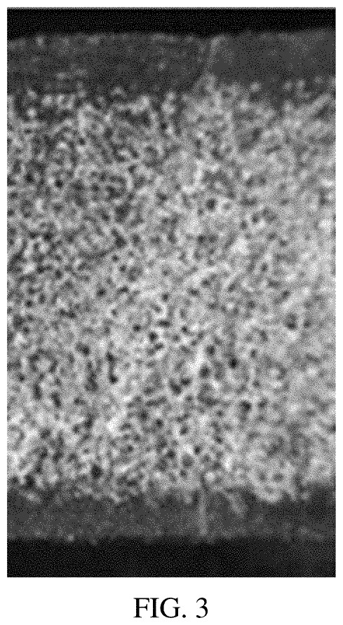

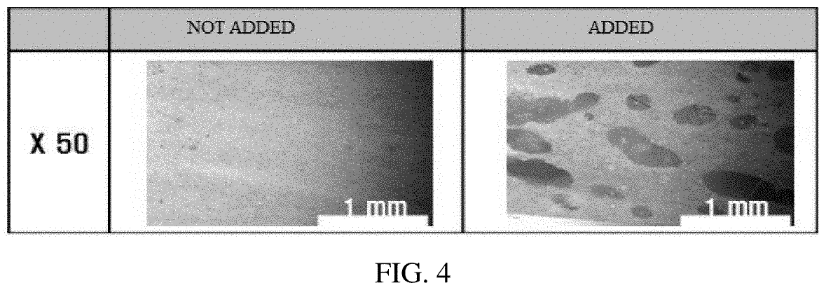

In the sound insulation sheet 20 formed as described above, as shown in FIG. 3, it can be seen that the thermoexpandable microcapsules 20′ are foamed in an overall thickness of the sound insulation sheet 20, and air pores are uniformly generated therein. In addition, as shown in FIG. 4, it can be seen that the air pores, which are not present in a sound insulation sheet to which thermoexpandable microcapsules 20′ are not added, are formed in the sound insulation sheet to which the thermoexpandable microcapsules 20′ are added.

The sound insulation sheet formed according to the present invention has a tensile strength of 1 to 2.8 Mpa, a tensile elongation of 160 to 230%, a specific gravity of 1.1 to 1.6, a hardness (Shore A) of 60 to 80, and a weight of 3.6 to 7.0 Kg.

C. Foam Sheet

As shown in FIG. 3, the foam sheet 30 is integrally formed on one surface of the sound insulation sheet 20. In this case, the foam sheet 30 separately manufactured by being foamed may be used, or the foam sheet 30 may be directly foamed on the sound insulation sheet 20 to be integrally formed with the sound insulation sheet 20.

Any sheet which can be formed by being foamed may be used as the foam sheet 30, but it is most preferable that a sheet manufactured by foaming polyurethane is used as the foam sheet 30.

In the dash insulation pad for a vehicle formed as described above according to the present invention, the fiber layer has a surface density of 1000 g/m², the sound insulation sheet has a tensile strength of 1 to 2.8 Mpa, a tensile elongation of 160 to 230%, a specific gravity of 1.1 to 1.6, and a hardness (Shore A) of 60 to 80, and the foam sheet has a density of 85 Kg/m³. The dash insulation pad for a vehicle formed as described above has a weight of 3.6 to 7.0 Kg.

Meanwhile, performance test and sound insulation performance evaluation of working examples in which the thermoexpandable microcapsules are included in the sound insulation sheet as described above and a comparative example in which thermoexpandable microcapsules are not included in a sound insulation sheet will be described below.

1. Performance Evaluation

In each of the working examples and the comparative example, hard PET having a surface density of 1,000 g/m² was used to form a fiber layer, a polyurethane foam having a density of 85 Kg/m³ was used to form a foam sheet, and a composition of a sound insulation sheet used in this case is described in Table 1.

TABLE 1

| | Comparative | | | |
|---|---|---|---|---|
| Material | Example | Example 1 | Example 2 | Material |
| Gum Resin | 37 wt % | 36 wt % | 35 wt % | LG Chem, Lucene ™ |
| | | | | LC170 |
| Inorganic Filler | 55 wt % | 54 wt % | 52 wt % | CaCo₃ |
| Other Additives | 8 wt % | 8 wt % | 8 wt % | stearic acid, w-oil, |
| | | | | and carbon black |
| thermoexpandable | — | 2 wt % | 5 wt % | MATSUMOTO |
| microcapsules | | | | MICROSPHERE ™, |
| | | | | F-260D |

Particularly, a content of the thermoexpandable microcapsules in Example 1 and a content of the thermoexpandable microcapsules in Example 2 were different, and a performance test result of the working examples and the comparative example is described in Table 2.

TABLE 2

| | Fiber | | | | | | | Dash |
|---|---|---|---|---|---|---|---|---|
| | layer | Sound Insulation Sheet | | | | | Foam | Insulation |
| | Surface | Tensile | Tensile | | | | Sheet | Pad |
| | Density | Strength | Elongation | Specific | | Thickness | Density | Weight |
| Classification | (g/m²) | [Mpa] | (%) | Gravity | Shore A | (mm) | (Kg/m³) | (Kg) |
| Comparative | 1000 | 2.3 | 228 | 1.6 | 72.8 | 1.6 | 85 | 4.7 |
| Example | | | | | | | | |
| Example 1 | | 1.6 | 208 | 1.4 | 63.3 | 1.9 | | 4.3 |
| | | | | 14%↓ | | 17%↑ | | |
| Example 2 | | 1.5 | 176 | 1.3 | 65.7 | 2.0 | | 3.7 |
| | | | | 21%↓ | | 25%↑ | | |

As shown in Table 2, in performance of the working examples, it can be seen that the tensile strengths were slightly lowered from the tensile strength of the comparative example, but the specific gravities are lowered from the specific gravity of the comparative example by 10% or more, and the tensile elongation of the working examples was similar to the tensile elongation of the comparative example. As described above, while overall performance of the working examples according to the present invention are similar to that of the comparative example, particularly, the weight thereof can be decreased so that the dash insulation pad can be lightened.

2. Sound Insulation Performance Evaluation

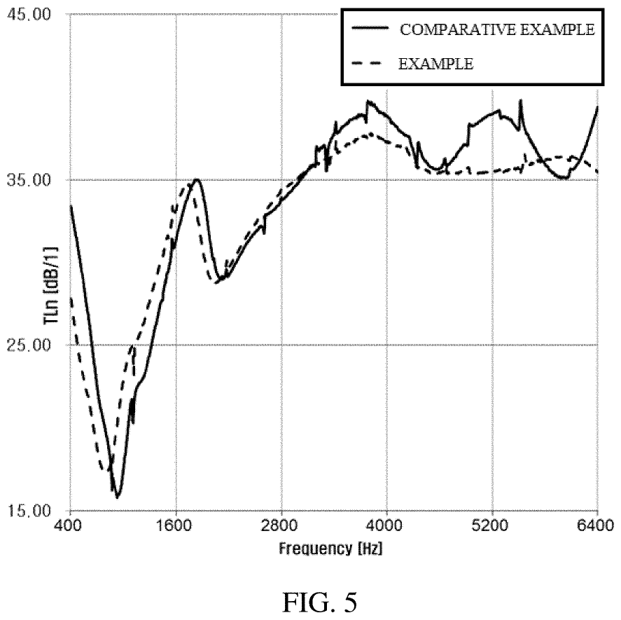

An evaluation result of sound insulation performance of the working examples and the comparative examples according to a change in a frequency will be shown in FIG. 5. In FIG. 5, a horizontal axis represents a frequency (Hz), a vertical axis represents sound insulation performance (TLn [dB/1]), a black line represents sound insulation performance of the comparative example, and a red line represents sound insulation performance of the working examples.

In the comparison of the sound insulation performance with reference to FIG. 5, it can be seen that sound insulation performance of the working example is equivalent to that of the comparative example in an overall frequency range, particularly, in a range from 500 Hz to 3 kHz. Therefore, it can be seen that the present invention can obtain sound insulation performance equivalent to that of a conventional case while the dash insulation pad is lightened using the sound insulation sheet.

The dash insulation pad for a vehicle according to the present invention has effects as described below.

(1) Since a sound insulation sheet is manufactured by adding thermoexpandable microcapsules thereto and foaming the thermoexpandable microcapsules, the sound insulation sheet can be lightened while an increase in weight of the sound insulation sheet can be minimized and required performance which is the same as or similar to that of a conventional sound insulation sheet can also be obtained.

(2) Particularly, since the thermoexpandable microcapsules individually expand to form air pores without using gas such as carbon dioxide or nitrogen so as to form a core shell structure, mechanical stiffness can be improved while an exterior feature is not degraded.

(3) Since a weight of the sound insulation sheet is decreased by about 10% or more from that of the conventional sound insulation sheet, a fuel efficiency of a vehicle can be improved.

(4) In addition, it can be expected that a tensile elongation of the sound insulation sheet is similar to that of the conventional sound insulation sheet, the weight thereof is expected to be decreased, and sound insulation performance which is equivalent to that of the conventional sound insulation sheet is also obtained at a frequency band of 500 Hz to 3 KHz even though the sound insulation sheet is light.

What is claimed is:

1. A dash insulation pad for a vehicle, in which a fiber layer, a sound insulation sheet including thermoexpandable microcapsules, and a foam sheet are sequentially formed.

2. The dash insulation pad of claim 1, wherein:
the fiber layer includes polyethylene terephthalate (PET); and
the foam sheet includes a polyurethane sheet.

3. The dash insulation pad of claim 1, wherein the sound insulation sheet is formed by mixing and foaming a gum resin at 30 to 40 wt %, an inorganic filler at 50 to 60 wt %, other additives (stearic acid, w-oil, and carbon black) at 8 wt %, and the thermoexpandable microcapsules (20′) at 0.5 to 10 wt %.

4. The dash insulation pad of claim 3, wherein a tensile strength of the sound insulation sheet is in a range of 1 to 2.8 Mpa

5. The dash insulation pad of claim 3, wherein a tensile elongation of the sound insulation sheet is in a range of 160 to 230%.

6. The dash insulation pad of claim 3, wherein a specific gravity of the sound insulation sheet is in a range of 1.1 to 1.6.

7. The dash insulation pad of claim 3, wherein a hardness (Shore A) of the sound insulation sheet is in a range of 60 to 80.

8. The dash insulation pad of claim 3, wherein a weight of the sound insulation sheet is in a range of 3.6 to 7.0 Kg.

9. The dash insulation pad of claim 1, wherein the sound insulation sheet is manufactured through a calendering process.

10. A method of manufacturing the dash insulation pad of claim 1, comprising the step of manufacturing the dash insulation pad through a calendering process.
